(19) United States
(12) Patent Application Publication
(10) Pub. No.: US 2007/0040863 A1
(43) Pub. Date: Feb. 22, 2007

(54) Inkjet printer

(75) Inventors: Toshihiro Nakajima, Kashiwa-shi (JP); Saburo Komatsu, Kashiwa-shi (JP)

Correspondence Address: NATH & ASSOCIATES, 112 South West Street, Alexandria, VA, 22314, US

(73) Assignee: MELTEC Corporation

(21) Appl. No.: 11/501,018

(22) Filed: Aug. 9, 2006

(30) Foreign Application Priority Data
Aug. 16, 2005 (JP) 235882/05
Aug. 16, 2005 (JP) 235883/05

(51) Int. Cl. B41J 29/393

(52) U.S. Cl. 347/19

(57) ABSTRACT

A rotary encoder scale and a linear encoder scale both made of plastic are provided in operating directions of a printing paper feed motor and a print head driving motor respectively in an inkjet printer. In one or each surface of each of the rotary encoder scale and the linear encoder scale, a metal film is formed in a portion excluding a region to be read by the encoder sensor for reading divisions. The surface of the metal film is grounded to a metal chassis or the like of the inkjet printer. Thus, an inkjet printer for preventing ink mist from adhering thereto can be obtained.

### FIELD OF THE INVENTION

The present invention relates to an inkjet printer in which ink mist flying during printing can be prevented from adhering to a plastic-film linear encoder scale and a plastic-film rotary encoder scale used in the inkjet printer and the ink mist adhering to the linear encoder scale and the rotary encoder scale can be dealt with.

### DESCRIPTION OF THE BACKGROUND ART

Generally, an inkjet printer is provided with a paper feed mechanism for feeding set printing paper in a fixed direction and a head feed mechanism for moving a print head unit in a direction perpendicular to the paper feed direction. A plurality of nozzles are provided in the print head unit. Printing is performed with ink sprayed from the nozzles while the printing paper is fed in the fixed direction and the print head unit is moved in the direction perpendicular to the paper feed direction.

A rotary encoder scale and a linear encoder scale are disposed in the paper feed mechanism and the head feed mechanism respectively. How far the printing paper should be fed and how far the print head unit should be moved are determined based on the rotary encoder scale. That is, the longitudinal feed of the paper and the transverse feed of the print head are performed by motors, and the feed distances obtained by these motors depend on the encoder scale. On the other hand, at what timing and from which nozzles ink should be sprayed is determined by the linear encoder scale.

That is, a scale pattern is formed in each encoder scale so that the encoder scale is provided with divisions at small intervals. A sensor for reading the divisions of the encoder scale is disposed in the print head unit. The motor is operated till the sensor detects a predetermined number of divisions from a reference division of the rotary encoder scale, and stopped as soon as the sensor detects the predetermined number of divisions. The sensor reads divisions of the linear encoder scale and determines the timing when ink is sprayed from nozzles. Thus, proper printing is performed by properly detecting the divisions of the encoder scales.

Patent Document 1: JP-A-2000-15795

However, the scales may be stained with the printing ink when the scales are used for a long time. The functions of the scales may be lost.

The reason will be described. During a printing operation, ink is sprayed from nozzles, or particles of the ink are bounced off from printing paper or a portion close thereto. In such a case, a very small part of the ink flying as mist adheres to the surfaces of the linear encoder scale and the rotary encoder scale. Particularly in recent years, due to frameless printing in widespread use, ink is printed to overlap between the edge of printing paper and the outside thereof. Thus, ink mist is apt to fly. In addition, the surface of plastic serving as the material of these scales is apt to be charged due to the effect of static electricity. Thus, it is conceived that the ink mist clings to the surface in a comparatively short time. Further, each reading sensor is designed to run along the surface of its corresponding encoder scale. The ink mist having a very small dot-like shape at the moment that the ink mist is attached to the surface of the encoder scale grows up gradually. When the reading sensor soon abuts against the ink mist, the ink mist is enlarged like a line along the moving direction of the reading sensor, and the line is further widened. Thus, the ink mist extends two-dimensionally. The reading sensor reads parallel stripe divisions formed at very small intervals in the encoder scale, so as to control the operation of its corresponding motor. There can occur a failure in reading due to the stain of the ink mist on the divisions.

### SUMMARY OF THE INVENTION

An object of the present invention is to provide an inkjet printer in which ink mist flying during printing can be prevented from adhering to a plastic-film linear encoder scale and a plastic-film rotary encoder scale, and the ink mist adhering thereto can be dealt with.

To solve the foregoing object, an inkjet printer according to a first configuration of the present invention includes: a rotary encoder scale for controlling a paper feed amount of printing paper, the rotary encoder scale being made of plastic; a linear encoder scale for controlling a feed amount of a print head unit, the linear encoder scale being made of plastic; and encoder sensors for reading divisions of the rotary encoder scale and the linear encoder scale respectively; wherein a metal film is formed on in a portion of one or each surface of each of the rotary encoder scale and the linear encoder scale excluding a region to be read by the encoder sensor for reading the divisions of the encoder scale, and a surface of the metal film is grounded to a metal chassis or the like of the inkjet printer.

An inkjet printer according to a second configuration of the present invention further includes: mist wiping members attached to vicinities of the encoder sensors for reading the divisions of the rotary encoder scale and the linear encoder scale respectively, the mist wiping members abutting against front surfaces or front and back surfaces of the rotary encoder scale and the linear encoder scale respectively.

An inkjet printer according to a third configuration of the present invention is designed so that the rotary encoder scale and the linear encoder scale are formed by attaching plastic films to front and back surfaces of plastic base materials printed with scale patterns respectively, the plastic films being high in repellency, thin and high in transparency; and the inkjet printer further includes mist wiping members attached to vicinities of the encoder sensors for reading the divisions of the rotary encoder scale and the linear encoder scale respectively, the mist wiping members abutting against front surfaces or front and back surfaces of the rotary encoder scale and the linear encoder scale respectively.

According to the first configuration of the invention, a metal film is formed in a portion of one or each surface of each of the rotary encoder scale and the linear encoder scale excluding a region to be read, and a surface of the metal film is grounded to a metal chassis or the like of the inkjet printer. Accordingly, the surface of the metal film is hardly charged. As a result, the amount of mist of printing ink clinging to the surface of the encoder scale is reduced so that its original function is kept for a longer time. Thus, the durability as the encoder scale is improved.

According to the second configuration of the invention, mist wiping members to abut against front surfaces or front and back surfaces of the rotary encoder scale and the linear encoder scale are attached to the vicinities of encoder sensors of the ink mist adhesion preventing apparatus according to the first configuration, respectively. Accordingly, even if ink mist flying during printing adheres to the surfaces of the encoder scales in the form of particulates, the particulates can be wiped off easily by the mist wiping members. Thus, the surfaces of the rotary encoder scale and the linear encoder scale are always kept so clean that accurate reading can be secured.

According to the third configuration of the invention, divisions printed on the base materials of the rotary encoder scale and the linear encoder scale are coated with transparent films. Accordingly, the divisions can be read accurately by the reading sensors. The films are so high in repellency that even if ink mist flying during printing adheres to the surfaces of the encoder scales in the form of particulates, the particulates can be wiped off easily by the mist wiping members. Thus, the surfaces of the rotary encoder scale and the linear encoder scale are always kept so clean that accurate reading can be secured.

### BRIEF DESCRIPTION OF THE DRAWINGS

FIG. 1 is a schematic view showing a main portion of an inkjet printer according to the present invention;

FIG. 2 is a perspective view of a rotary encoder scale according to a first embodiment;

FIG. 3 is a perspective view sectionally showing a part of the rotary encoder scale in FIG. 2;

FIG. 4 is a perspective view of a linear encoder scale according to the first embodiment;

FIG. 5 is a perspective view sectionally showing a part of the linear encoder scale in FIG. 4;

FIG. 6 is a perspective view of a rotary encoder scale according to a second embodiment;

FIG. 7 is a perspective view sectionally showing a part of the rotary encoder scale in FIG. 6;

FIG. 8 is a perspective view of a linear encoder scale according to the second embodiment; and

FIG. 9 is a perspective view sectionally showing a part of the linear encoder scale in FIG. 8.

### DETAILED DESCRIPTION OF THE INVENTION

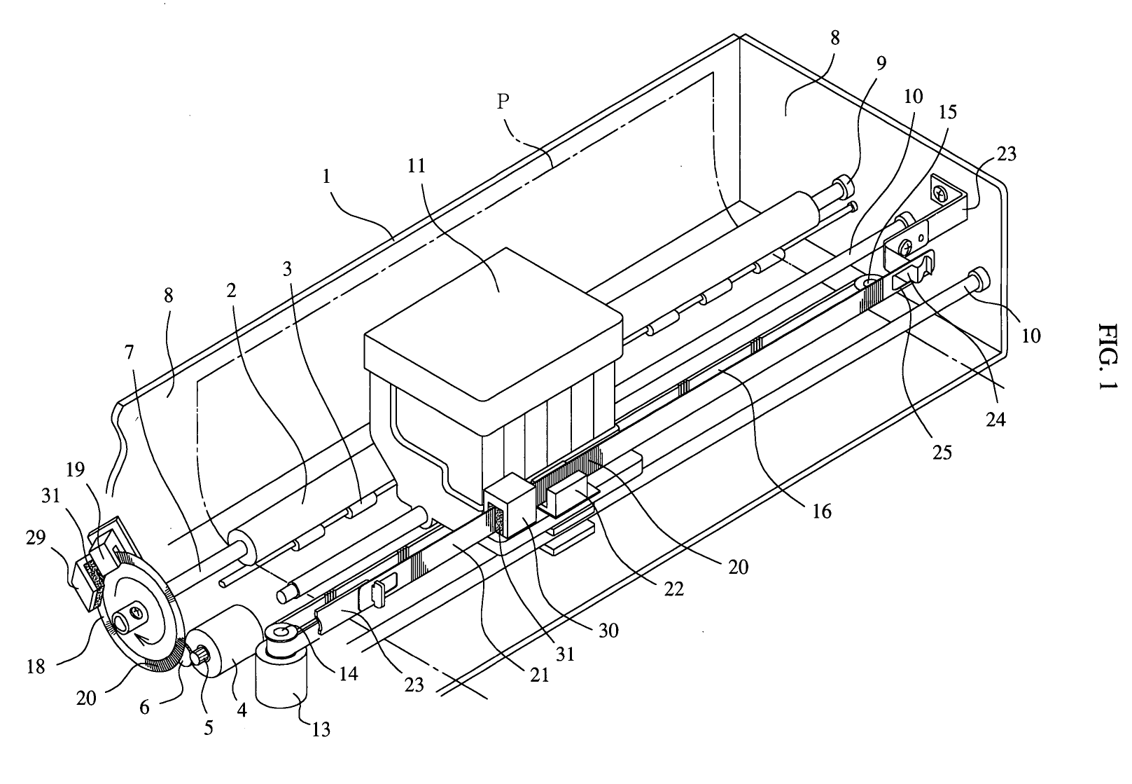

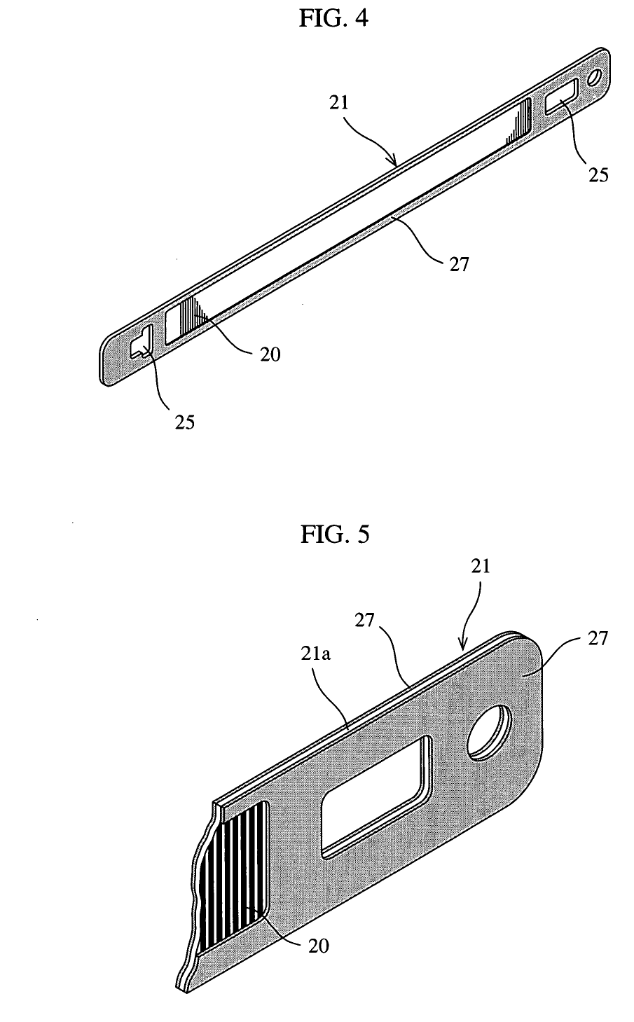

A first embodiment of the present invention will be described with reference to FIGS. 1 to 5. This embodiment relates to an ink mist adhesion preventing apparatus in which ink mist flying during printing can be prevented from adhering to a linear encoder scale and a rotary encoder scale. FIG. 1 is a schematic view of a main portion of an inkjet printer. In FIG. 1, the reference numeral 1 represents a chassis made of metal. Inside the chassis 1, a paper feed roller 2 is disposed in a direction perpendicular to the paper feed direction. A paper press roller 3 is disposed under the paper feed roller 2. Printing paper P is put between the paper feed roller 2 and the paper press roller 3. When the paper feed roller 2 is rotated, the printing paper P is sent in a fixed direction.

The reference numeral 4 represents a paper feed roller driving motor. A gear 5 provided on an output shaft of the motor 4 is engaged with a gear (not shown) provided on a rotating shaft 7 of the paper feed roller 2 through a reduction gear 6 so as to rotate the paper feed roller 2. The rotating shaft 7 is made of metal, and one end (or each end) thereof abuts against a side wall 8 of the chassis 1 through a bearing 9.

Next, two guide rods 10 are disposed in parallel with the paper feed roller 2. A print head unit 11 is slidably supported on the guide rods 10. Nozzles (not shown) for spraying printing ink are disposed in a lower portion of the print head unit 11.

The reference numeral 13 represents a print head unit driving motor. The motor 13 is disposed on the one-end side of the guide rods 10, while a pulley 14 is disposed on the other end side. A driving belt 16 is wound between a pulley 15 and the pulley 14. The pulley 15 is provided on an output shaft of the motor 13. A part of the driving belt 16 is fixed to a lower portion of the print head unit 11.

The printing paper P is disposed to move under the inkjet nozzles of the print head unit 11 while being put between the paper feed roller 2 and the paper press roller 3.

Next, longitudinal paper feed and transverse print head unit feed are controlled when printing is performed on the printing paper P by the paper feed mechanism and the head unit feed mechanism. A rotary encoder scale 18 provided on the rotating shaft 7 of the paper feed roller 2 is read by a transmission type reading sensor 19 so as to control the amount of rotation of the rotating shaft 7. Thus, the paper feed amount is controlled. Stripe divisions 20 are printed circumferentially at minute intervals in the surface of the rotary encoder scale 18. The divisions 20 are read by the reading sensor 19. The motor 4 is operated till the sensor 19 detects a predetermined number of divisions from a reference division of the rotary encoder scale 18. The motor 4 is stopped as soon as the sensor 19 detects the predetermined number of divisions.

Next, feeding the print head unit 11 and spraying the ink are controlled by a transmission type reading sensor 22 reading the linear encoder scale 21. The linear encoder scale 21 is provided so that opening portions 25 formed in the opposite ends of the linear encoder scale 21 are locked in hooks 24 of mounting brackets 23 fixed to the side walls 8 of the chassis 1. The reading sensor 22 is fixed to the print head unit 11 so that the reading sensor 22 can read the linear encoder scale 21. Stripe divisions 20 are printed longitudinally at minute intervals in the surface of the linear encoder scale 21. The divisions 20 are read by the reading sensor 22. Ink is sprayed from the nozzles of the print head unit 11 as soon as the sensor 22 detects a predetermined number of divisions from a reference division.

In the aforementioned configuration, ink is sprayed from the nozzles of the print head unit 11 at the timing when the printing paper P and the print head unit 11 are fed longitudinally and transversely by predetermined feed amounts respectively. Thus, printing can be made in a predetermined position of the printing paper P. Such an operation is repeated continuously so as to print characters or drawings.

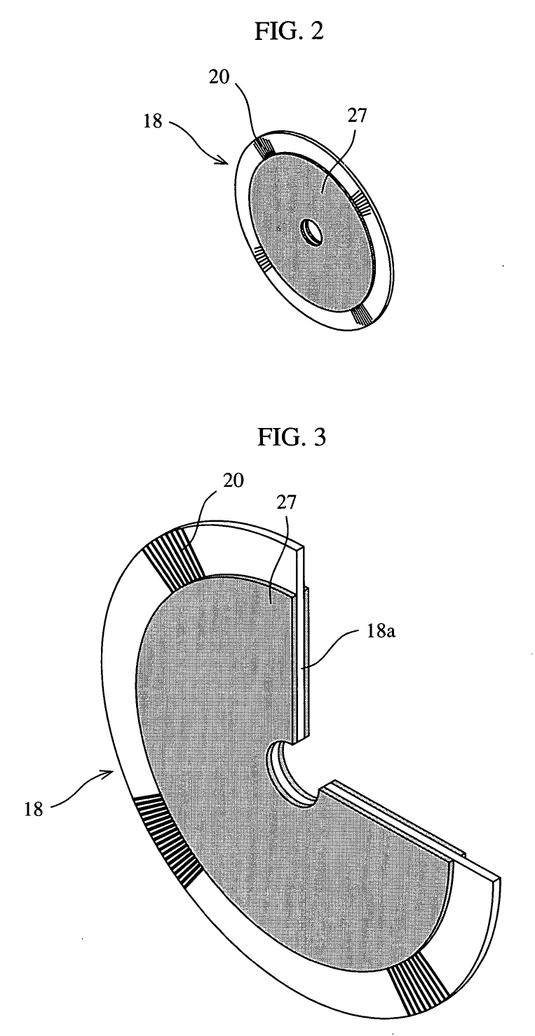

Next, as shown in FIGS. 2 to 5, each of the encoder scales (rotary encoder scale and linear encoder scale) 18 and 21 is made of plastic, and the minute stripe divisions 20 are printed in the surface of a core base material 18a, 21a thereof excluding its opposite end portions. In the surface of the base material 18a, 21a, a metal film 27 is formed in a portion excluding a region to be read by the encoder sensor for reading the divisions.

The metal film 27 may be formed in the following methods.

(1) To deposit metal such as chrome, aluminum, nickel, gold, silver or the like.

(2) To screen-print or paint a selected printing or painting paint kneaded with metal powder etc. (aluminum, copper, gold, silver, carbon, etc.)

(3) To laminate and fix a metal plate of stainless, aluminum, brass or the like to the encoder scale 18, 21 by pressing, etching or the like, the metal plate being as large as the encoder scale 18, 21 and having a readable region open.

The metal film 27 of the rotary encoder scale 21 is grounded to the chassis through the rotating shaft of the paper feed roller. The metal film 27 of the linear encoder scale 18 is grounded to the chassis through the mounting brackets. To ground the metal films 27, tension springs, screws, caulking or the like may be used.

In the aforementioned configuration, static electricity is not charged into the portion of the surface of the encoder scale 18, 21 coated with the metal film 27. Accordingly, the encoder scale as a whole is hardly charged, either. Even if a very small part of ink flies as mist and swims inside the chassis in the form of very small droplets when the ink is sprayed from the nozzles during the printing operation or when particles of the ink are bounced off from the printing paper, the ink mist is hardly attracted by the surface of the encoder scale 18, 21, and hardly attached thereto. Thus, the divisions of the encoder scale 18, 21 are prevented from being stained, so that their original function can be maintained for a long time.

The scales and the sensors may be reflection types.

The metal films 27 may be designed to be pasted only to the printed surfaces of the encoder scales.

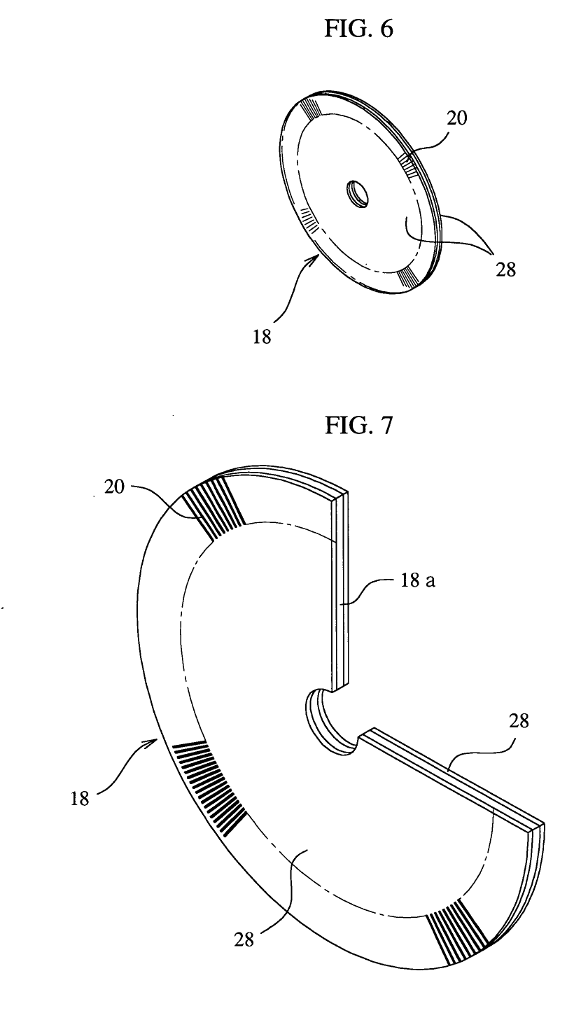

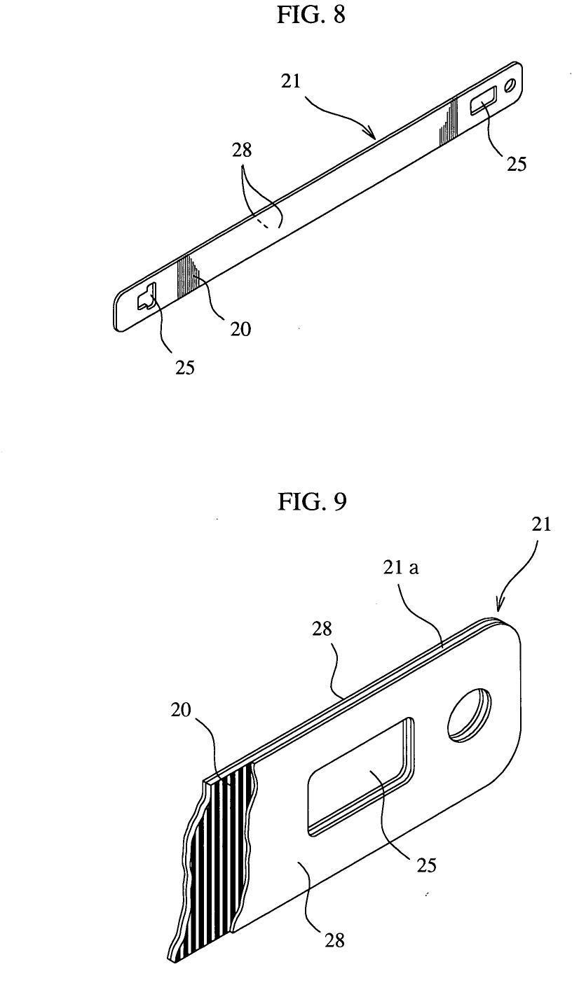

Next, a second embodiment of the present invention will be described with reference to FIG. 1 and FIGS. 6-9. This embodiment relates to an apparatus for dealing with attached ink mist. In the surface of the core base material 18a, 21a of the encoder scale 18, 20 made of plastic as shown in FIG. 1, minute stripe divisions 20 are printed excluding the opposite end portions thereof. Plastic films 28 high in repellency, thin and high in transparency are pasted to the front and back surfaces of the base material through adhesive high in transparency.

Mist wiping members 29 and 30 are disposed and fixed in the vicinities of the reading sensors 19 and 22 for the rotary encoder scale 18 and the linear encoder scale 21 by suitable means. A sponge-like ink absorber 31 is attached to each mist wiping member 29, 30. The ink absorber 31 abuts against the opposite surfaces of the corresponding one of the rotary encoder scale 18 and the linear encoder scale 21.

The mist wiping member 29, 30 and the reading sensor 19, 22 are preferably disposed so that the divisions can be read after mist is wiped off.

According to the aforementioned configuration, the divisions 20 printed in the base material 18a, 21a is coated with the transparent film 28 so that the divisions 20 can be read accurately by the reading sensor 19, 22.

When ink is sprayed from the nozzles during the printing operation or when particles of the ink are bounced off from the printing paper, a very small part of the ink flying as mist may swim inside the chassis 1 in the form of very small droplets and adhere to the front and back surfaces of the encoder scale 18, 21. However, when passing through the mist wiping member 29, 30, the ink in the form of droplets is wiped off and absorbed in the ink absorber. The front and back surfaces of the encoder scale 18, 21 are so high in repellency that the mist adhering thereto becomes particulates. Thus, the mist is wiped off easily by the mist wiping member 29, 30. Accordingly, the surfaces of the rotary encoder scale 18 and the linear encoder scale 21 are also kept so clean that accurate reading can be secured for a long time.

The scales and the sensors may be reflection types.

What is claimed is:

1. An inkjet printer comprising:
a rotary encoder scale for controlling a paper feed amount of printing paper, the rotary encoder scale being made of plastic;
a linear encoder scale for controlling a feed amount of a print head unit, the linear encoder scale being made of plastic; and
encoder sensors for reading divisions of the rotary encoder scale and the linear encoder scale respectively;
wherein a metal film is formed in a portion of one or each surface of each of the rotary encoder scale and the linear encoder scale excluding a region to be read by the encoder sensor for reading the divisions of the encoder scale, and a surface of the metal film is grounded to a metal chassis or the like of the inkjet printer.

2. An inkjet printer according to claim 1, further comprising:
mist wiping members attached to vicinities of the encoder sensors for reading the divisions of the rotary encoder scale and the linear encoder scale respectively, the mist wiping members abutting against front surfaces or front and back surfaces of the rotary encoder scale and the linear encoder scale respectively.

3. An inkjet printer according to claim 1, wherein:
the rotary encoder scale and the linear encoder scale are formed by attaching plastic films to front and back surfaces of plastic base materials printed with scale patterns respectively, the plastic films being high in repellency, thin and high in transparency; and
the inkjet printer further comprises mist wiping members attached to vicinities of the encoder sensors for reading the divisions of the rotary encoder scale and the linear encoder scale respectively, the mist wiping members abutting against front surfaces or front and back surfaces of the rotary encoder scale and the linear encoder scale respectively.
